(19) United States
(12) Patent Application Publication
(10) Pub. No.: US 2012/0092513 A1
(43) Pub. Date: Apr. 19, 2012

(54) NOVEL AND ROBUST METHOD FOR COMPUTING CONTROL POINTS

(75) Inventors: Earl Wong, San Jose, CA (US); Mamoru Sugiura, Yokohama (JP); Masato Watanabe, Omiya (JP)

(73) Assignee: SONY CORPORATION, Tokyo (JP)

(21) Appl. No.: 12/906,838

(22) Filed: Oct. 18, 2010

(51) Int. Cl. H04N 5/225; G06K 9/00; G06K 9/46

(52) U.S. Cl. 348/222.1; 382/201; 382/154; 348/E05.024

(57) ABSTRACT

A method of and system for computing control points in a test target are described herein. The method and system utilize symmetry to test pixel locations in a raster scan fashion, then a computed Sum of Absolute Differences or a Sum of Squared Difference value is stored at the pixel locations, which enables identification of local minimum in the resulting surface. The local minimum are control point locations.

### FIELD OF THE INVENTION

The present invention relates to the field of image processing. More specifically, the present invention relates to computing control points of an image.

### BACKGROUND OF THE INVENTION

Many techniques exist for computing the control points in a test target. Gradient/edge-based methods work well for sharp images. However, the performance of these methods degrades when the image is subject to moderate amounts of blur/de-focus. Statistical methods are more robust to image blur. Unfortunately, moment-based methods require qualitative a priori knowledge of the control point locations. This becomes problematic if the a priori knowledge becomes “inaccurate.” This is able to occur in the following ways: 1) there is a change in camera angle of view, 2) the test target or camera undergoes a modest amount of rotation or 3) the camera lens has a significant distortion.

### SUMMARY OF THE INVENTION

A method of and system for computing control points in a test target are described herein. The method and system utilize symmetry to test pixel locations in a raster scan fashion, then a computed Sum of Absolute Differences or a Sum of Squared Difference value is stored at the pixel locations, which enables identification of local minimum in the resulting surface. The local minimum control point locations.

In one aspect, a method of computing a control point in an image programmed in a memory in a device comprises applying a symmetry test at pixel locations in the image, storing a computed value of each of the pixel locations and identifying a local minimum in a resulting surface from the computed values. Applying the symmetry test comprises computing a Sum of Absolute Differences value or a Sum of Squared Differences value. The symmetry test is applied in a raster scan fashion. The computed value is a Sum of Absolute Differences value or a Sum of Squared Differences value. The method further comprises generating a three dimensional surface using the computed value of each of the pixel locations. The image is a test pattern comprising symmetric objects. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.

In another aspect, a system for computing a control point in an image programmed in a memory in a device comprises a symmetry test module for testing pixel locations in the image for symmetry, a storing module for storing a computing value of each of the pixel locations and an identification module for identifying a local minimum. The symmetry test module further comprises computing a Sum of Absolute Differences value or a Sum of Squared Differences value. The symmetry test is applied in a raster scan fashion. The computed value is a Sum of Absolute Differences value or a Sum of Squared Differences value. The system further comprises a generation module for generating a three dimensional surface using the computed value of each of the pixel locations. The image is a test pattern comprising symmetric objects. The device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.

In yet another aspect, a camera device comprises an image acquisition component for acquiring an image, a processing component for processing the image by applying a symmetry test at pixel locations in the image, storing a computed value of the pixel locations and identifying a local minimum in a resulting surface from the computed values and a memory for storing the processed image. Applying the symmetry test comprises computing a Sum of Absolute Differences value or a Sum of Squared Differences value. The symmetry test is applied in a raster scan fashion. The computed value is a Sum of Absolute Differences value or a Sum of Squared Differences value. The processing component is further for generating a three dimensional surface using the computed value of each of the pixel locations. The image is a test pattern comprising symmetric objects.

### BRIEF DESCRIPTION OF THE DRAWINGS

FIG. 1 illustrates examples of symmetric objects.

FIG. 2 illustrates examples of different kinds of symmetry.

FIG. 3 illustrates an exemplary test pattern using a square object.

FIG. 4 illustrates examples of a bounding box applied around a region of interest and testing of symmetry according to some embodiments.

FIG. 5 illustrates a diagram of a three dimensional surface generated by applying symmetry and computing an SAD or SSD for each pixel according to some embodiments.

FIG. 6 illustrates a flowchart of a method of computing control points utilizing symmetry according to some embodiments.

FIG. 7 illustrates a block diagram of an exemplary computing device configured to implement the method of computing control points according to some embodiments.

### DETAILED DESCRIPTION OF THE PREFERRED EMBODIMENT

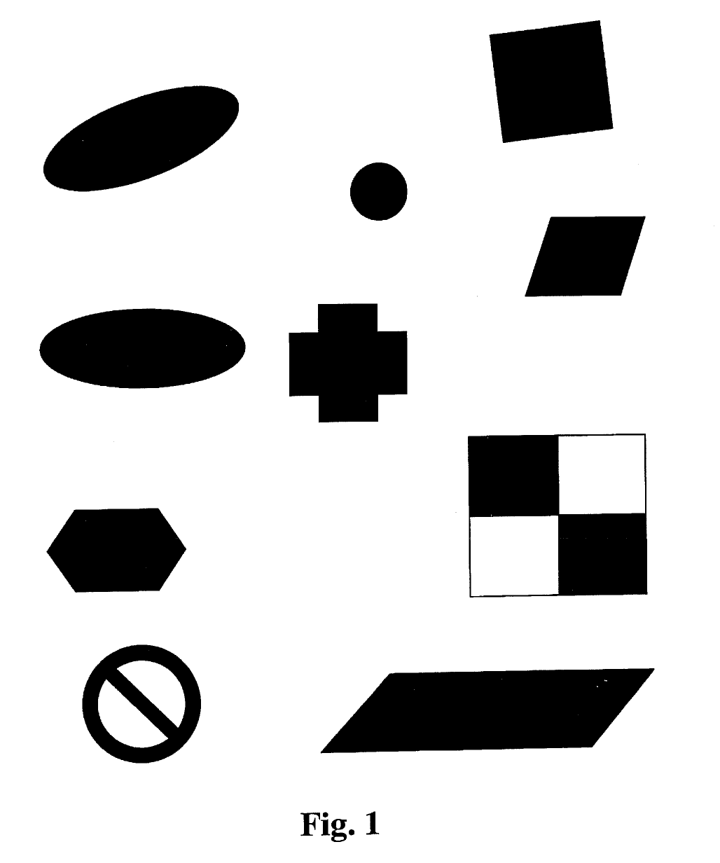

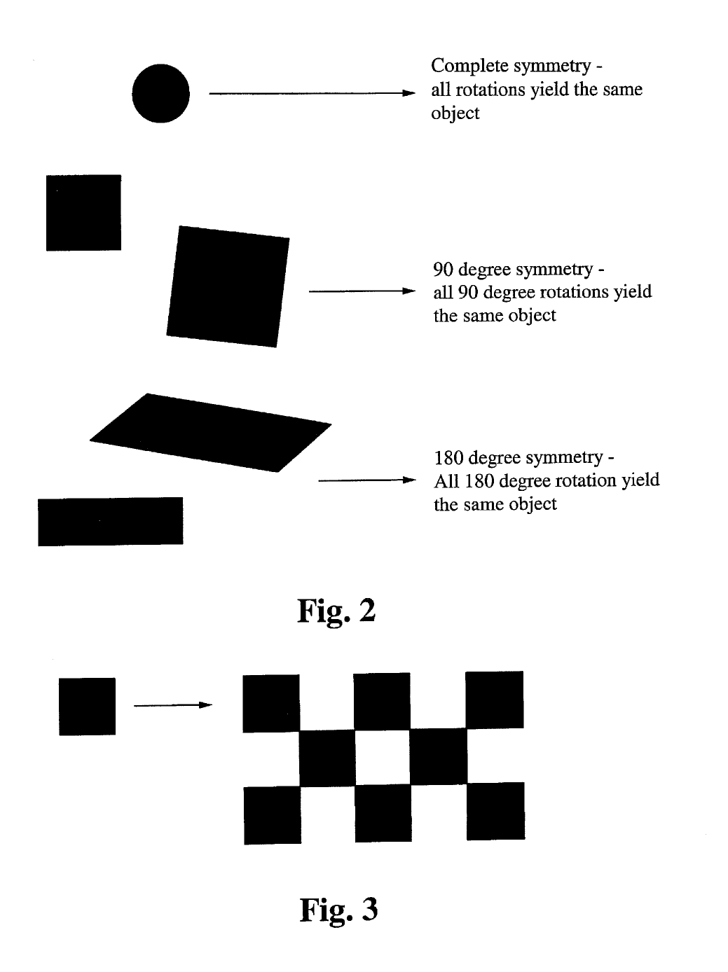

The method and system for computing control points described herein addresses the issues of the prior art. To compute control points, the mathematical concept of symmetry is utilized. FIG. 1 illustrates examples of symmetric objects. In particular, there are different kinds of symmetry as is shown in FIG. 2. A circle has complete symmetry where all rotations yield the same object. Squares have 90 degree symmetry where all 90 degree rotations yield the same object. Rectangles and parallelograms have 180 degree symmetry where all 180 degree rotations yield the same object. From the objects, many test patterns are able to be formed. FIG. 3 illustrates an exemplary test pattern using a square object.

If a bounding box is applied around a region of interest and symmetry of the object is tested, it is discovered: 1) the Sum of Absolute Differences (SAD) is minimum and 2) the Sum of Squared Differences (SSD) is minimum, when the box is centered on a region of interest.

This information is used to identify control point locations.

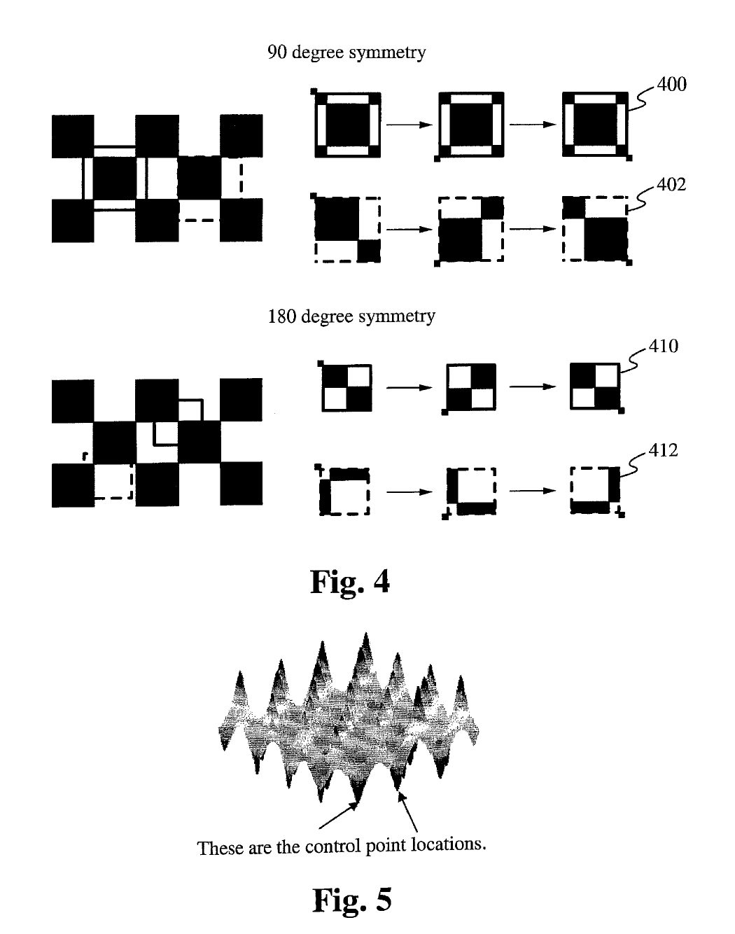

FIG. 4 illustrates examples of a bounding box applied around a region of interest and testing of symmetry according to some embodiments. In the 90 degree symmetry selection, the solid line region of interest selection 400 is symmetric, and the object is centered. This results in a calculation of a minimum. The dotted line region of interest selection 402 is not symmetric, and the object is not centered. This does not result in a minimum calculation. In the 180 degree symmetry selection, the solid line region of interest selection 410 is symmetric and results in a minimum calculation. The dotted line region of interest selection 412 is not symmetric and does not result in minimum calculation.

FIG. 5 illustrates a diagram of a three dimensional surface generated by applying symmetry and computing an SAD or SSD for each pixel according to some embodiments. From the SAD and/or SSD values computed, the three dimensional surface is generated. The minimums of the three dimensional surface are the control point locations.

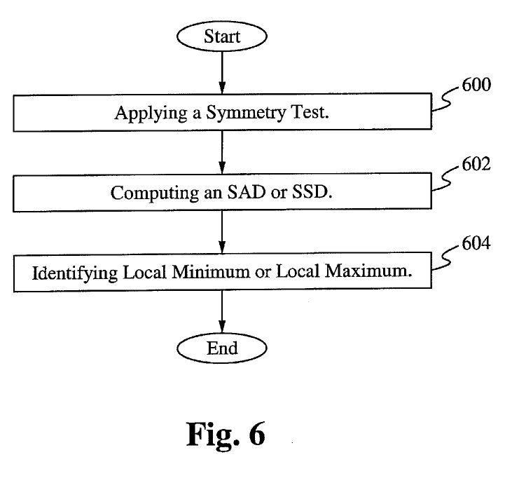

FIG. 6 illustrates a flowchart of a method of computing control points utilizing symmetry according to some embodiments. In the step 600, a symmetry test is applied at every pixel location. In some embodiments, the symmetry test includes computing SAD and/or SSD values. In some embodiments, the test is applied in a raster scan fashion. In the step 602, the computed SAD or SSD values are stored at the pixel locations. In some embodiments, a three dimensional surface is generated using the stored values. In the step 604, a local minimum is identified in a resulting surface. The local minimum(s) are the control point locations. In some embodiments, additional or fewer steps included.

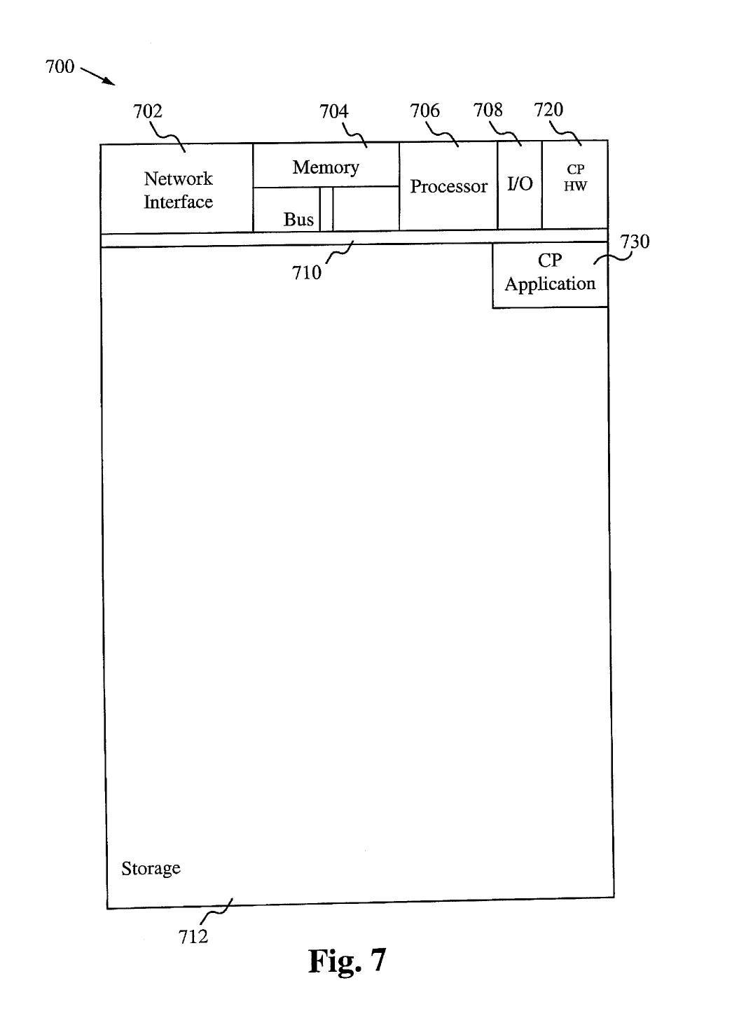

FIG. 7 illustrates a block diagram of an exemplary computing device 700 configured to implement the method of computing control points according to some embodiments. The computing device 700 is able to be used to process information such as images and videos. For example, a computing device 700 is able to determine control points of an image. In general, a hardware structure suitable for implementing the computing device 700 includes a network interface 702, a memory 704, a processor 706, I/O device(s) 708, a bus 710 and a storage device 712. The choice of processor is not critical as long as a suitable processor with sufficient speed is chosen. The memory 704 is able to be any conventional computer memory known in the art. The storage device 712 is able to include a hard drive, CDROM, CDRW, DVD, DVDRW, Blu-ray disc™, flash memory card or any other storage device. The computing device 700 is able to include one or more network interfaces 702. An example of a network interface includes a network card connected to an Ethernet or other type of LAN. The I/O device(s) 708 are able to include one or more of the following: keyboard, mouse, monitor, display, printer, modem, touchscreen, button interface and other devices. Control point application(s) 730 used to perform the method of computing control points are likely to be stored in the storage device 712 and memory 704 and processed as applications are typically processed. More or less components than shown in FIG. 7 are able to be included in the computing device 700. In some embodiments, control point hardware 720 is included. Although the computing device 700 in FIG. 7 includes applications 730 and hardware 720 for computing control points, the method of computing control points is able to be implemented on a computing device in hardware, firmware, software or any combination thereof.

In some embodiments, the control point application(s) 730 include several applications and/or modules. In some embodiments, the control point application(s) 730 include modules such as a symmetry test module for testing pixel locations for symmetry, a storing module for sotring an SAD or an SSD, a generation module for generating a three dimensional surface using the computed value of each of the pixel locations and an identification module for identifying a local minimum. In some embodiments, fewer or additional modules and/or sub-modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a Blu-Ray® writer/player, a television, a home entertainment system or any other suitable computing device.

To utilize the method of computing control points, a device such as a digital camera is used at a scene to acquire an image or video of the scene. The method of computing control points is able to automatically be used with the autofocusing operation to perform the autofocusing quickly and accurately. Then, the user acquires an image or video of the scene. The method of computing control points is able to be used with other operations as well. The method of computing control points is also able to be implemented after the image is acquired to perform post-acquisition processing.

In operation, the method of computing control points robustly and efficiently utilizes symmetry to compute control points in an image. The method is able to be used for many applications including, but not limited to, feature point extraction, salient point detection, lens characterization and target testing.

### Some Embodiments of A Novel And Robust Method For Computing Control Points

1. A method of computing a control point in an image programmed in a memory in a device comprising:

a. applying a symmetry test at pixel locations in the image;

b. storing a computed value of each of the pixel locations; and

c. identifying a local minimum in a resulting surface from the computed values.

2. The method of clause 1 wherein applying the symmetry test comprises computing a Sum of Absolute Differences value or a Sum of Squared Differences value.
3. The method of clause 1 wherein the symmetry test is applied in a raster scan fashion.
4. The method of clause 1 wherein the computed value is a Sum of Absolute Differences value or a Sum of Squared Differences value.
5. The method of clause 1 further comprising generating a three dimensional surface using the computed value of each of the pixel locations.
6. The method of clause 1 wherein the image is a test pattern comprising symmetric objects.
7. The method of clause 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.
8. A system for computing a control point in an image programmed in a memory in a device comprising:

a. a symmetry test module for testing pixel locations in the image for symmetry;

b. a storing module for storing a computing value of each of the pixel locations; and

c. an identification module for identifying a local minimum.

9. The system of clause 8 wherein the symmetry test module further comprises computing a Sum of Absolute Differences value or a Sum of Squared Differences value.
10. The system of clause 8 wherein the symmetry test is applied in a raster scan fashion.
11. The system of clause 8 wherein the computed value is a Sum of Absolute Differences value or a Sum of Squared Differences value.
12. The system of clause 8 further comprising a generation module for generating a three dimensional surface using the computed value of each of the pixel locations.
13. The system of clause 8 wherein the image is a test pattern comprising symmetric objects.
14. The system of clause 8 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.
15. A camera device comprising:

a. an image acquisition component for acquiring an image;

b. a processing component for processing the image by:
i. applying a symmetry test at pixel locations in the image;
ii. storing a computed value of the pixel locations; and
iii. identifying a local minimum in a resulting surface from the computed values; and

c. a memory for storing the processed image.

16. The camera device of clause 15 wherein applying the symmetry test comprises computing a Sum of Absolute Differences value or a Sum of Squared Differences value.
17. The camera device of clause 15 wherein the symmetry test is applied in a raster scan fashion.
18. The camera device of clause 15 wherein the computed value is a Sum of Absolute Differences value or a Sum of Squared Differences value.
19. The camera device of clause 15 wherein the processing component is further for generating a three dimensional surface using the computed value of each of the pixel locations.
20. The camera device of clause 15 wherein the image is a test pattern comprising symmetric objects.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. A method of computing a control point in an image programmed in a memory in a device comprising:
a. applying a symmetry test at pixel locations in the image;
b. storing a computed value of each of the pixel locations; and
c. identifying a local minimum in a resulting surface from the computed values.

2. The method of claim 1 wherein applying the symmetry test comprises computing a Sum of Absolute Differences value or a Sum of Squared Differences value.

3. The method of claim 1 wherein the symmetry test is applied in a raster scan fashion.

4. The method of claim 1 wherein the computed value is a Sum of Absolute Differences value or a Sum of Squared Differences value.

5. The method of claim 1 further comprising generating a three dimensional surface using the computed value of each of the pixel locations.

6. The method of claim 1 wherein the image is a test pattern comprising symmetric objects.

7. The method of claim 1 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.

8. A system for computing a control point in an image programmed in a memory in a device comprising:
a. a symmetry test module for testing pixel locations in the image for symmetry;
b. a storing module for storing a computing value of each of the pixel locations; and
c. an identification module for identifying a local minimum.

9. The system of claim 8 wherein the symmetry test module further comprises computing a Sum of Absolute Differences value or a Sum of Squared Differences value.

10. The system of claim 8 wherein the symmetry test is applied in a raster scan fashion.

11. The system of claim 8 wherein the computed value is a Sum of Absolute Differences value or a Sum of Squared Differences value.

12. The system of claim 8 further comprising a generation module for generating a three dimensional surface using the computed value of each of the pixel locations.

13. The system of claim 8 wherein the image is a test pattern comprising symmetric objects.

14. The system of claim 8 wherein the device is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a Blu-ray® writer/player, a television and a home entertainment system.

15. A camera device comprising:
a. an image acquisition component for acquiring an image;
b. a processing component for processing the image by:
i. applying a symmetry test at pixel locations in the image;
ii. storing a computed value of the pixel locations; and
iii. identifying a local minimum in a resulting surface from the computed values; and
c. a memory for storing the processed image.

16. The camera device of claim 15 wherein applying the symmetry test comprises computing a Sum of Absolute Differences value or a Sum of Squared Differences value.

17. The camera device of claim 15 wherein the symmetry test is applied in a raster scan fashion.

18. The camera device of claim 15 wherein the computed value is a Sum of Absolute Differences value or a Sum of Squared Differences value.

19. The camera device of claim 15 wherein the processing component is further for generating a three dimensional surface using the computed value of each of the pixel locations.

20. The camera device of claim 15 wherein the image is a test pattern comprising symmetric objects.
